(19) United States
(12) Patent Application Publication
(10) Pub. No.: US 2018/0102659 A1
(43) Pub. Date: Apr. 12, 2018

(54) VEHICLE ELECTRICAL APPARATUS WITH PROTECTION AND DETECTION MECHANISM FOR REVERSE POWER CONNECTION

(71) Applicant: REC Technology Corporation, Taoyuan City (TW)

(72) Inventor: Chien-Ming Chen, Taoyuan City (TW)

(73) Assignee: REC Technology Corporation, Taoyuan City (TW)

(21) Appl. No.: 15/435,314

(22) Filed: Feb. 17, 2017

(30) Foreign Application Priority Data
Oct. 12, 2016 (TW) 105215456

(51) Int. Cl. H02J 7/00; B60L 11/18

(52) U.S. Cl. CPC H02J 7/0045; B60L 11/1816; H02J 7/0026

(57) ABSTRACT

A vehicle electrical apparatus including a power pin, a ground pin, a conversion circuit, a detection circuit and an electrical device is provided. The conversion circuit is coupled to the power pin and the ground pin to receive a first voltage signal and a second voltage signal respectively, and generates a system voltage and a ground voltage. The detection circuit detects a polarity of at least one of the first voltage signal and the second voltage signal, and generates a detection signal. The electrical device has a power terminal receiving the system voltage, a ground terminal receiving the ground voltage and a control terminal receiving the detection signal. The electrical device enables a first function when determining that the polarities of the first voltage signal and the power pin are different and the polarities of the second voltage signal and the ground pin are different according to the detection signal.

### CROSS-REFERENCE TO RELATED APPLICATION

This application claims the priority benefit of Taiwan application serial no. 105215456, filed on Oct. 12, 2016. The entirety of the above-mentioned patent application is hereby incorporated by reference herein and made a part of this specification.

### BACKGROUND

### Field of the Invention

The invention is directed to an electrical apparatus and more particularly, to a vehicle electrical apparatus with a protection and detection mechanism for reverse power connection, which is capable of detecting whether power input terminals of the vehicle electrical apparatus are normally or reversely connected with an external power supply and accordingly enabling corresponding functions.

### Description of Related Art

In a general scenario, power input terminals of a vehicle electrical apparatus must be normally (or correctly) connected with an external power supply (i.e., a positive power supply terminal of the external power supply is coupled to a positive power input terminal of the vehicle electrical apparatus, and a negative power supply terminal of the external power supply is coupled to a negative power input terminal of the vehicle electrical apparatus), such that the vehicle electrical apparatus can be operated normally in this way. In case the external power supply and the power input terminals of the vehicle electrical apparatus are reversely connected, the vehicle electrical apparatus may be probably burned out.

In addition, the vehicle electrical apparatus can provide various additional functions. However, different consumers (or purchasers of the vehicle electrical apparatus) have different demands for the additional functions of the vehicle electrical apparatus. Therefore, how to provide different consumers with the additional functions on demand by the same vehicle electrical apparatus to achieve a purpose of customization is an important subject to the technicians of the art.

### SUMMARY

Accordingly, the invention provides a vehicle electrical apparatus with a protection and detection mechanism for reverse power connection. The vehicle electrical apparatus is capable of detecting whether power input terminals thereof are reversely connected with an external power supply and accordingly enabling different functions of the vehicle electrical apparatus, so as to achieve a purpose of customization.

A vehicle electrical apparatus of the invention includes a power pin, a ground pin, a conversion circuit, a polarity detection circuit and an electrical device. The conversion circuit is coupled to the power pin to receive a first voltage signal and coupled to the ground pin to receive a second voltage signal, so as to generate a system voltage to a power path and generate a ground voltage to a ground path. The polarity detection circuit is configured to detect a polarity of at least one of the first voltage signal and the second voltage signal and accordingly generate a polarity detection signal. The electrical device has a power terminal, a ground terminal and a control terminal. The power terminal is coupled to the power path to receive the system voltage, the ground terminal is coupled to the ground path to receive the ground voltage, and the control terminal is coupled to the polarity detection circuit to receive the polarity detection signal. The electrical device enables a first function when determining that according to the polarity detection signal, the polarity of the first voltage signal and a polarity of the power pin are different, and the polarity of the second voltage signal and a polarity of the ground pin are different.

In an embodiment of the invention, the electrical device does not enable the first function when determining that according to the polarity detection signal, the polarities of the first voltage signal and the power pin are the same, and the polarities of the second voltage signal and the ground pin are the same.

In an embodiment of the invention, the electrical device enables a second function when determining that according to the polarity detection signal, the polarities of the first voltage signal and the power pin are the same, and the polarities of the second voltage signal and the ground pin are the same, wherein the first function and the second function are different.

To sum up, the vehicle electrical apparatus can be normally operated no matter whether the power input terminals (i.e., the power pin and the ground pin) of the vehicle electrical apparatus are normally (i.e., correctly) or reversely connected with the external power supply. In addition, the vehicle electrical apparatus can further detect whether the power input terminals of the vehicle electrical apparatus are normally or reversely connected with the external power supply and accordingly provide corresponding vehicle electrical functions, so as to achieve the purpose of customization.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a vehicle electrical apparatus according to an embodiment of the invention.

FIG. 2A is a schematic circuit diagram illustrating the polarity detection circuit according to an embodiment of the invention.

FIG. 2B is a schematic circuit diagram illustrating a polarity detection circuit according to another embodiment of the invention.

FIG. 3 is a schematic block diagram illustrating a vehicle electrical apparatus according to another embodiment of the invention.

FIG. 4A is a schematic circuit diagram illustrating the polarity detection circuit according to an embodiment of the invention.

FIG. 4B is a schematic circuit diagram illustrating the polarity detection circuit according to another embodiment of the invention.

FIG. 5 is a schematic block diagram illustrating a vehicle electrical apparatus according to yet another embodiment of the invention.

### DESCRIPTION OF EMBODIMENTS

In order to make the content of the invention clearer, the following embodiments are illustrated as examples that can be truly implemented by the invention. Wherever possible, elements/members using the same reference numbers in the drawings and the description refer to the same or like parts.

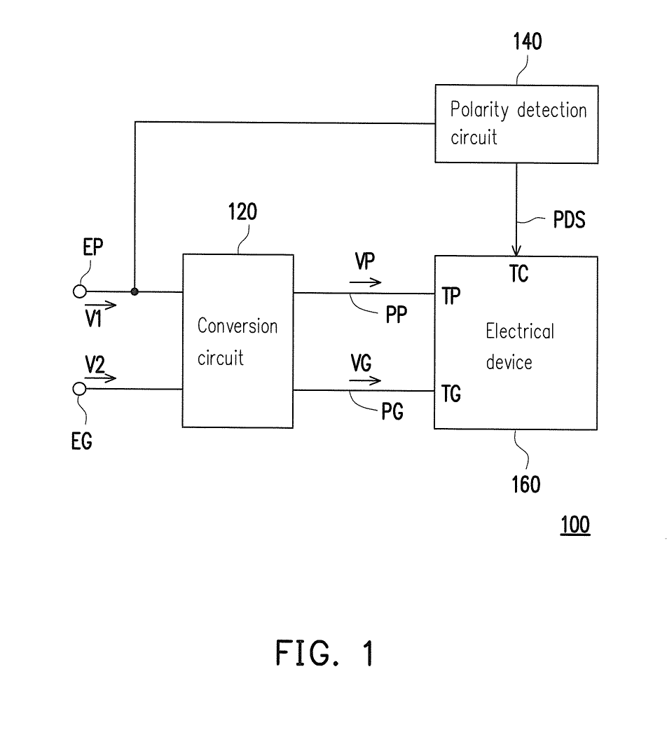

Referring to FIG. 1 hereinafter, FIG. 1 is a schematic block diagram illustrating a vehicle electrical apparatus 100 according to an embodiment of the invention. The vehicle electrical apparatus 100 is provided with a protection and detection mechanism for reverse power connection. Specifically, the vehicle electrical apparatus 100 may be normally operated no matter whether power input terminals of the vehicle electrical apparatus 100 are normally or reversely connected with an external power supply. Additionally, the vehicle electrical apparatus 100 may also detect whether the power input terminals of the vehicle electrical apparatus 100 are normally or reversely connected with the external power supply and accordingly providing corresponding vehicle electrical functions, so as to achieve a purpose of customization.

In an embodiment of the invention, the vehicle electrical apparatus 100 may be any electrical product used in a vehicle. For example, the vehicle electrical apparatus 100 may be, for example, a driving recorder host, a vehicle camera, a vehicle navigation system or a vehicle audio and a video playback apparatus and so on, which construes no limitations to the invention. The type of the vehicle electrical apparatus 100 is not limited in the invention.

Furthermore, as illustrated in FIG. 1, the vehicle electrical apparatus 100 may include a power pin EP, a ground pin EG, a conversion circuit 120, a polarity detection circuit 140 and an electrical device 160, but the invention is not limited thereto. Therein, the power pin EP and the ground pin EG are power input terminals of the vehicle electrical apparatus 100. The conversion circuit 120 is coupled to the power pin EP to receive a first voltage signal V1. The conversion circuit 120 is coupled to the ground pin EG to receive a second voltage signal V2. The conversion circuit 120 may generate a system voltage VP to a power path PP and generate a ground voltage VG to a ground path PG according to the first voltage signal V1 and the second voltage signal V2, so as to normally supply power to the polarity detection circuit 140 and the electrical device 160. The first voltage signal V1 and the second voltage signal V2 are provided by the external power supply. In other words, the conversion circuit 120 is capable of providing power required for normal operations of the polarity detection circuit 140 and the electrical device 160 no matter whether the power pin EP and the ground pin EG of the vehicle electrical apparatus 100 are normally or reversely connected with the external power supply, so as to achieve a purpose of protection for reverse power connection. In an embodiment of the invention, the conversion circuit 120 may be, for example, a bridge rectifier, but the invention is not limited thereto.

In the embodiment illustrated in FIG. 1 of the invention, the polarity detection circuit 140 may be configured to detect a polarity of the first voltage signal V1 and accordingly generate a polarity detection signal PDS. Furthermore, the polarity detection circuit 140 may detect whether the polarity of the first voltage signal V1 and a predetermined polarity of the power pin EP are the same, thereby detecting whether the power pin EP and the ground pin EG of the vehicle electrical apparatus 100 are normally or reversely connected with the external power supply.

The electrical device 160 has a power terminal TP, a ground terminal TG and a control terminal TC. The power terminal TP is coupled to the power path PP to receive the system voltage VP. The ground terminal TG is coupled to the ground path PG to receive the ground voltage VG. The control terminal TC is coupled to the polarity detection circuit 140 to receive the polarity detection signal PDS. The electrical device 160 enables a first function when determining that the polarities of the first voltage signal V1 and the power pin EP are different and the polarities of the second voltage signal V2 and the ground pin EG are different according to the polarity detection signal PDS. That is, when the power pin EP and the ground pin EG of the vehicle electrical apparatus 100 are reversely connected with the external power supply, the electrical device 160 enables the first function.

By contrast, in an embodiment of the invention, the electrical device 160 does not enable the first function when determining that the polarities of the first voltage signal V1 and the power pin EP are the same and the polarities of the second voltage signal V2 and the ground pin EG are the same according to the polarity detection signal PDS. That is, when the power pin EP and the ground pin EG of the vehicle electrical apparatus 100 are normally connected with the external power supply, the electrical device 160 does not enable the first function.

Furthermore, the first function may be a specific auxiliary or additional function of the electrical device 160 which is desired by a customer. For example, if it is assumed that the vehicle electrical apparatus 100 is a driving recorder, the first function may be, for example, displaying an auxiliary line for backing a vehicle on a screen, compensating an environment light source during driving to render a captured image clearer or the like, which depends on an actual application or demand, but the invention is not limited thereto.

In another embodiment of the invention, the electrical device 160 enables a second function when determining that the polarities of the first voltage signal V1 and the power pin EP are the same and the polarities of the second voltage signal V2 and the ground pin EG are the same according to the polarity detection signal PDS, where the second function is different from the aforementioned first function. That is, when the power pin EP and the ground pin EG of the vehicle electrical apparatus 100 are normally connected with the external power supply, the electrical device 160 enables the second function different from the first function. For example, if it is assumed that the vehicle electrical apparatus 100 is the driving recorder, the aforementioned first function may be, for example, displaying the auxiliary line for backing the vehicle on the screen, and the second function may be, for example, enabling a white balance function of a vehicle camera, which depends on the actual application or demand, but the invention is not limited thereto.

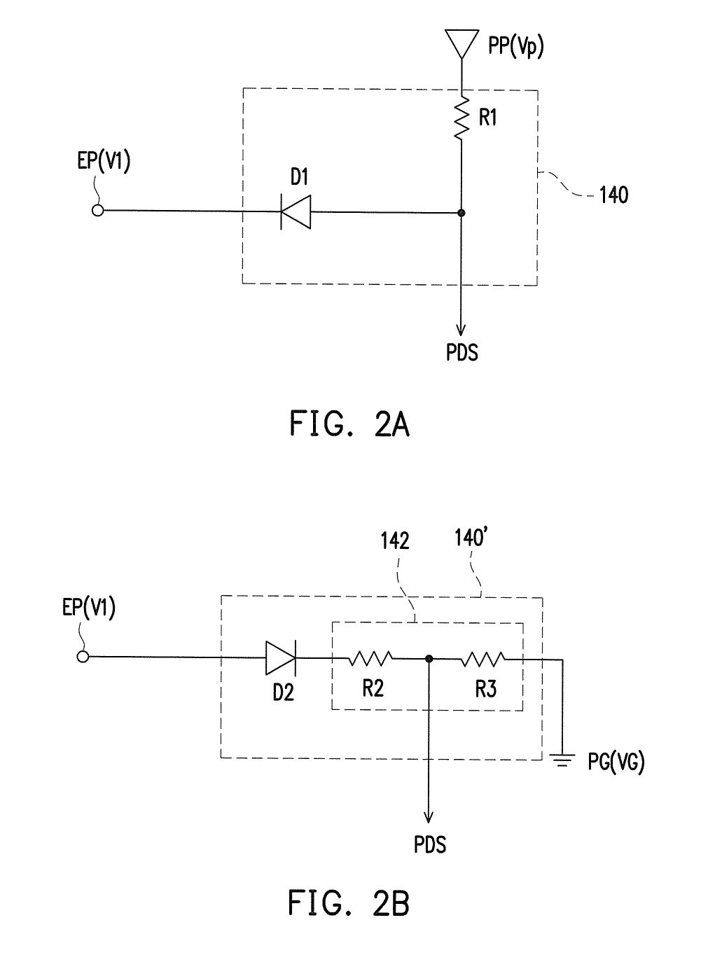

Referring to FIG. 1 and FIG. 2A simultaneously hereinafter, FIG. 2A is a schematic circuit diagram illustrating the polarity detection circuit 140 according to an embodiment of the invention. The polarity detection circuit 140 includes a resistor R1 and a diode D1. The resistor R1 is coupled between the power path PP and the control terminal TC of the electrical device 160 to generate the polarity detection signal PDS. An anode terminal of the diode D1 is coupled to the control terminal TC of the electrical device 160, and a cathode terminal of the diode D1 is coupled to the power pin EP.

If it is assumed herein that the first voltage signal V1 (which is provided to the power pin EP by the external power supply) and the system voltage VP on the power path PP are 5 volts (V), and the second voltage signal V2 (which is provided to the ground pin EG by the external power supply) and the ground voltage VG on the ground path PG are 0 V, the power pin EP and the ground pin EG are normally connected with the external power supply. In this circumstance, the diode D1 illustrated in FIG. 2A is in a turned-off state. Thus, the polarity detection signal PDS is at a logic high level. Hence, the electrical device 160 may determine that the power pin EP and the ground pin EG are normally connected with the external power supply according to the polarity detection signal PDS at the logic high level and thereby, only enable an internal basic function of the electrical device 160, for example.

On the other hand, if it is assumed that the second voltage signal V2 (which is provided to the ground pin EG by the external power supply) and the system voltage VP on the power path PP are 5 V, and the first voltage signal V1 (which is provided to the power pin EP by the external power supply) and the ground voltage VG on the ground path PG are 0 V, the power pin EP and the ground pin EG are reversely connected with the external power supply. In this circumstance, the diode D1 illustrated in FIG. 2A is turned on for being in a forward-biased state. Thus, the polarity detection signal PDS is at a logic low level. Hence, the electrical device 160 may determine that the power pin EP and the ground pin EG are reversely connected with the external power supply according to the polarity detection signal PDS at the logic low level and thereby, enable an internal basic function and another auxiliary function of the electrical device 160, for example. Therein, said another auxiliary function may be, for example, the aforementioned first function (which is determined based on the customer's demand).

Referring to FIG. 1 and FIG. 2B simultaneously hereinafter, FIG. 2B is a schematic circuit diagram illustrating a polarity detection circuit 140′ according to another embodiment of the invention. The polarity detection circuit 140′ includes a diode D2 and a voltage-division circuit 142. An anode terminal of the diode D2 is coupled to the power pin EP. The voltage-division circuit 142 is coupled between a cathode terminal of the diode D2 and the ground path PG to generate the polarity detection signal PDS. The voltage-division circuit 142 includes resistors R2 and R3 connected in series.

If it is assumed herein that the first voltage signal V1 (which is provided to the power pin EP by the external power supply) and the system voltage VP on the power path PP are 5 V, and the second voltage signal V2 (which is provided to the ground pin EG by the external power supply) and the ground voltage VG on the ground path PG are 0 V, the power pin EP and the ground pin EG are normally connected with the external power supply. In this circumstance, the diode D2 illustrated in FIG. 2B is turned on for being in a forward-biased state. Thus, the polarity detection signal PDS is at a logic high level. Hence, the electrical device 160 may determine that the power pin EP and the ground pin EG are normally connected with the external power supply according to the polarity detection signal PDS at the logic low level and thereby, only enable an internal basic function of the electrical device 160, for example.

On the other hand, if it is assumed that the second voltage signal V2 (which is provided to the ground pin EG by the external power supply) and the system voltage VP on the power path PP are 5 V, and the first voltage signal V1 (which is provided to the power pin EP by the external power supply) and the ground voltage VG on the ground path PG are 0 V, the power pin EP and the ground pin EG are reversely connected with the external power supply. In this circumstance, the diode D2 illustrated in FIG. 2B is in a turned-off state. Thus, the polarity detection signal PDS is at a logic low level. Hence, the electrical device 160 may determine that the power pin EP and the ground pin EG are reversely connected with the external power supply according to the polarity detection signal PDS at the logic low level and thereby, enable the internal basic function and another auxiliary function of the electrical device 160, for example. Therein, said another auxiliary function may be, for example, the aforementioned first function (which is determined based on the customer's demand).

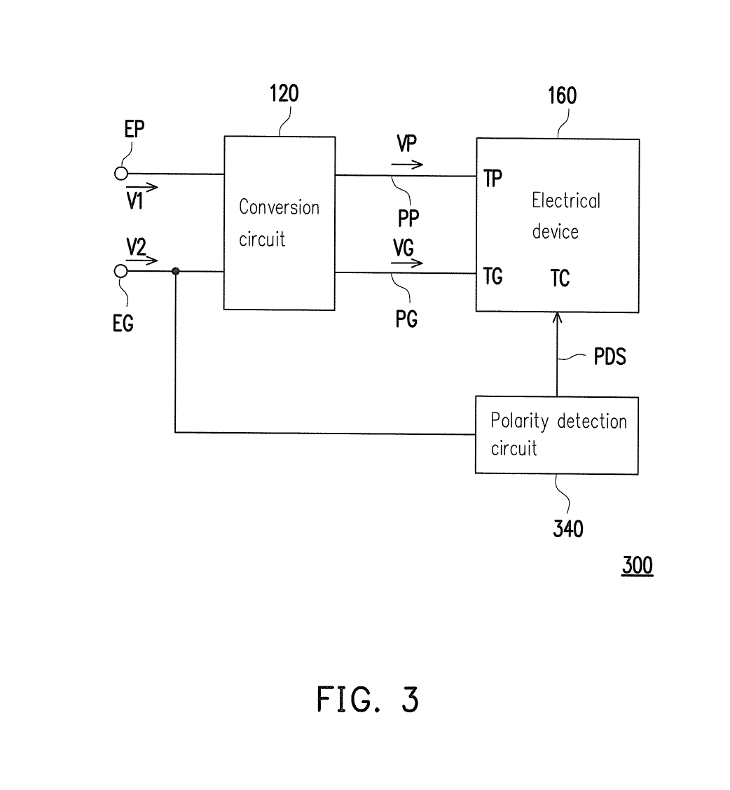

Referring to FIG. 3 hereinafter, FIG. 3 is a schematic block diagram illustrating a vehicle electrical apparatus 300 according to another embodiment of the invention. The vehicle electrical apparatus 300 includes a power pin EP, a ground pin EG, a conversion circuit 120, a polarity detection circuit 340 and an electrical device 160, but the invention is not limited thereto. The power pin EP, the ground pin EG, the conversion circuit 120 and the electrical device 160 illustrated in FIG. 3 are respectively similar to the power pin EP, the ground pin EG, the conversion circuit 120 and the electrical device 160 illustrated in FIG. 1, thus, may refer to descriptions related to FIG. 1 and will not be repeated hereinafter.

By being compared with the polarity detection circuit 140 illustrated in FIG. 1 which detects the polarity of the first voltage signal V1 and accordingly generates the polarity detection signal PDS, the polarity detection circuit 340 illustrated in FIG. 3 detects the polarity of the second voltage signal V2 and accordingly generates the polarity detection signal PDS. Furthermore, the polarity detection circuit 340 may detect whether the polarity of the second voltage signal V2 and the predetermined polarity of the ground pin EG are the same, so as to detect whether the power pin EP and the ground pin EG of the vehicle electrical apparatus 300 are normally or reversely connected with the external power supply.

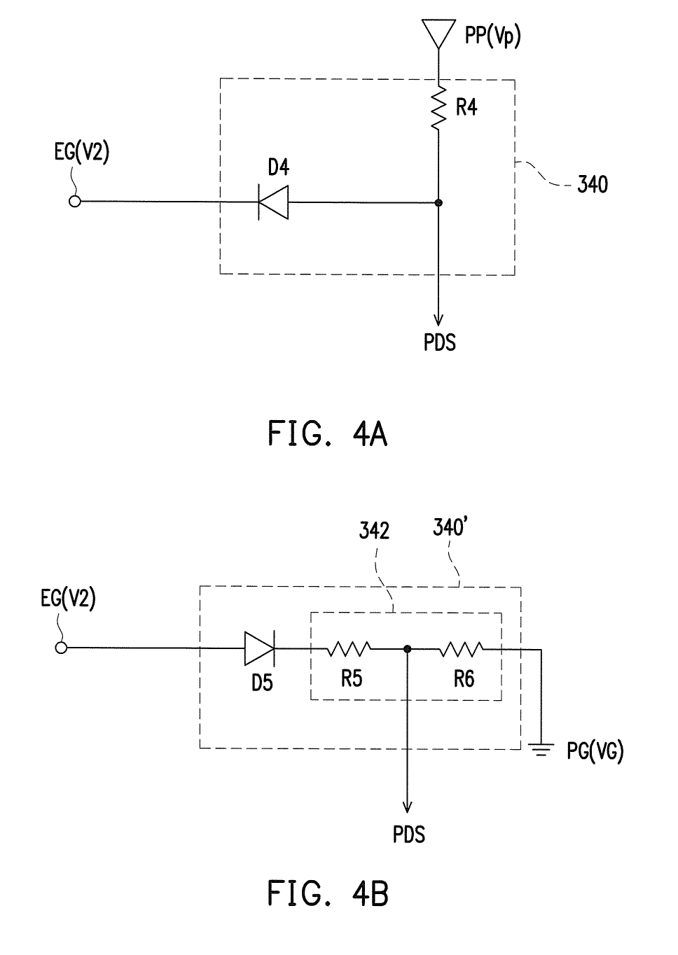

Referring to FIG. 3 and FIG. 4A simultaneously hereinafter, FIG. 4A is a schematic circuit diagram illustrating the polarity detection circuit 340 according to an embodiment of the invention. The polarity detection circuit 340 may include a resistor R4 and a diode D4. The resistor R4 is coupled between the power path PP and the control terminal TC of the electrical device 160 to generate the polarity detection signal PDS. An anode terminal of the diode D4 is coupled to the control terminal TC of the electrical device 160, and a cathode ten final of the diode D4 is coupled to the ground pin EG.

If it is assumed herein that the first voltage signal V1 (which is provided to the power pin EP by the external power supply) and the system voltage VP on the power path PP are 5 V, and the second voltage signal V2 (which is provided to the ground pin EG by the external power supply) and the ground voltage VG on the ground path PG are 0 V, the power pin EP and the ground pin EG are normally connected with the external power supply. In this circumstance, the diode D4 illustrated in FIG. 4A is turned on for being in a forward-biased state. Thus, the polarity detection signal PDS is at a logic low level. Hence, the electrical device 160 may determine that the power pin EP and the ground pin EG are normally connected with the external power supply according to the polarity detection signal PDS at the logic low level and thereby, only enable an internal basic function of the electrical device 160, for example.

On the other hand, if it is assumed that the second voltage signal V2 (which is provided to the ground pin EG by the external power supply) and the system voltage VP on the power path PP are 5 V, and the first voltage signal V1 (which is provided to the power pin EP by the external power supply) and the ground voltage VG on the ground path PG are 0 V, the power pin EP and the ground pin EG are reversely connected with the external power supply. In this circumstance, the diode D4 illustrated in FIG. 4A is in a turned-off state. Thus, the polarity detection signal PDS is at a logic high level. Hence, the electrical device 160 may determine that the power pin EP and the ground pin EG are reversely connected with the external power supply according to the polarity detection signal PDS at the logic high level and thereby, enable an internal basic function and another auxiliary function of the electrical device 160, for example. Therein, said another auxiliary function may be, for example, the aforementioned first function.

Referring to FIG. 3 and FIG. 4B simultaneously hereinafter, FIG. 4B is a schematic circuit diagram illustrating the polarity detection circuit 340′ according to another embodiment of the invention. The polarity detection circuit 340′ includes a diode D5 and a voltage-division circuit 342. An anode terminal of the diode D5 is coupled to the ground pin EG. The voltage-division circuit 342 is coupled between a cathode terminal of the diode D5 and the ground path PG to generate the polarity detection signal PDS. The voltage-division circuit 342 includes resistors R5 and R6 connected in series.

If it is assumed herein that the first voltage signal V1 (which is provided to the power pin EP by the external power supply) and the system voltage VP on the power path PP are 5 V, and the second voltage signal V2 (which is provided to the ground pin EG by the external power supply) and the ground voltage VG on the ground path PG are 0 V, the power pin EP and the ground pin EG are normally connected with the external power supply. In this circumstance, the diode D5 illustrated in FIG. 4B is in a turned-off state. Thus, the polarity detection signal PDS is at a logic low level. Hence, the electrical device 160 may determine that the power pin EP and the ground pin EG are normally connected with the external power supply according to the polarity detection signal PDS at the logic low level and thereby, only enable an internal basic function of the electrical device 160, for example.

On the other hand, if it is assumed that the second voltage signal V2 (which is provided to the ground pin EG by the external power supply) and the system voltage VP on the power path PP are 5 V, and the first voltage signal V1 (which is provided to the power pin EP by the external power supply) and the ground voltage VG on the ground path PG are 0 V, the power pin EP and the ground pin EG are reversely connected with the external power supply. In this circumstance, the diode D5 illustrated in FIG. 4B is turned on for being in a forward-biased state. Thus, the polarity detection signal PDS is at a logic high level. Hence, the electrical device 160 may determine that the power pin EP and the ground pin EG are reversely connected with the external power supply according to the polarity detection signal PDS at the logic high level and thereby, enable the internal basic function and another auxiliary function of the electrical device 160. Therein, said another auxiliary function may be, for example, the aforementioned first function.

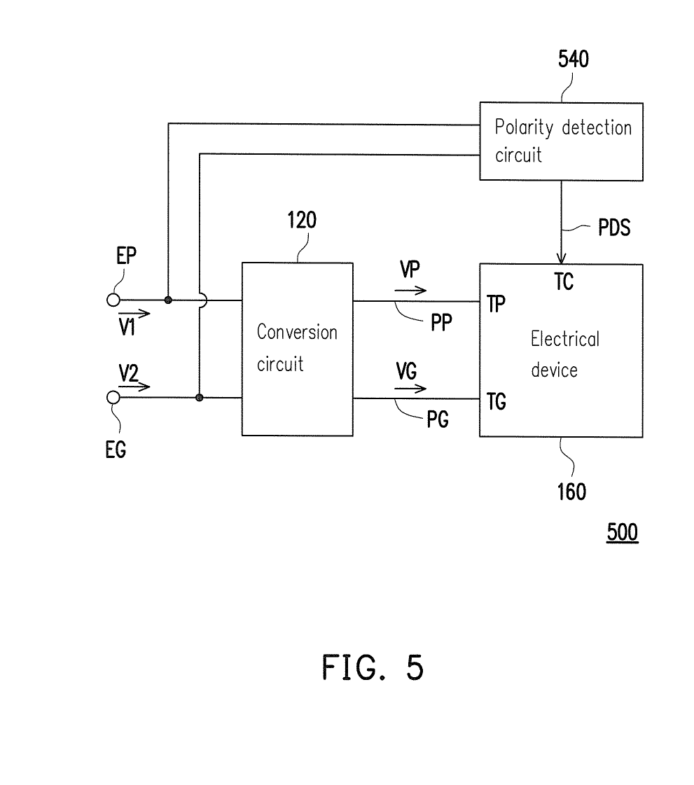

Referring to FIG. 5 hereinafter, FIG. 5 is a schematic block diagram illustrating a vehicle electrical apparatus 500 according to yet another embodiment of the invention. The vehicle electrical apparatus 500 may include a power pin EP, a ground pin EG, a conversion circuit 120, a polarity detection circuit 540 and an electrical device 160, but the invention is not limited thereto. The power pin EP, the ground pin EG, the conversion circuit 120 and the electrical device 160 illustrated in FIG. 5 are respectively similar to the power pin EP, the ground pin EG, the conversion circuit 120 and the electrical device 160 illustrated in FIG. 1, thus, may refer to descriptions related to FIG. 1 and will not be repeated hereinafter.

By being compared with the polarity detection circuit 140 illustrated in FIG. 1 which detects the polarity of the first voltage signal V1 and accordingly generates the polarity detection signal PDS, and the polarity detection circuit 340 illustrated in FIG. 3 which detects the polarity of the second voltage signal V2 and accordingly generates the polarity detection signal PDS, the polarity detection circuit 540 of the FIG. 5 simultaneously detects the polarities of the first voltage signal V1 and the second voltage signal V2 and accordingly generates the polarity detection signal PDS. Furthermore, the polarity detection circuit 540 may detect whether the polarity of the first voltage signal V1 and the predetermined polarity of the power pin EP are the same and detect whether the polarity of the second voltage signal V2 and the predetermined polarity of the ground pin EG are the same, so as to detect whether the power pin EP and the round pin EG of the vehicle electrical apparatus 500 are normally or reversely connected with the external power supply. When the polarity detection circuit 540 detects that the polarity of the first voltage signal V1 and the predetermined polarity of the power pin EP are the same, and the polarity of the second voltage signal V2 and the predetermined polarity of the ground pin EG are the same, it indicates that the power pin EP and the ground pin EG are normally connected with the external power supply. By contrast, when the polarity detection circuit 540 detects that the polarity of the first voltage signal V1 and the predetermined polarity of the power pin EP are different, and the polarity of the second voltage signal V2 and the predetermined polarity of the ground pin EG are different, it indicates that the power pin EP and the ground pin EG are reversely connected with the external power supply. The implementation manner and operation related to the polarity detection circuit 540 illustrated in FIG. 5 may be inferred according to the descriptions related to FIG. 1 to FIG. 4B and thus, will not be repeated hereinafter.

In light of the foregoing, no matter whether the power input terminals of the vehicle electrical apparatus provided by the embodiments of the invention are normally or reversely connected with the external power supply, the vehicle electrical apparatus can be normally operated. Moreover, the vehicle electrical apparatus can further detect whether the power input terminals thereof are normally or reversely connected with the external power supply, so as to provide corresponding vehicle electrical functions to achieve the purpose of customization.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A vehicle electrical apparatus with a protection and detection mechanism for reverse power connection, comprising:
a power pin;
a ground pin;
a conversion circuit, coupled to the power pin to receive a first voltage signal and coupled to the ground pin to receive a second voltage signal, so as to generate a system voltage to a power path and generate a ground voltage to a ground path;
a polarity detection circuit, configured to detect a polarity of at least one of the first voltage signal and the second voltage signal and accordingly generate a polarity detection signal; and
an electrical device, having a power terminal, a ground terminal and a control terminal, wherein the power terminal is coupled to the power path to receive the system voltage, the ground terminal is coupled to the round path to receive the ground voltage, and the control terminal is coupled to the polarity detection circuit to receive the polarity detection signal,
wherein the electrical device enables a first function when determining that according to the polarity detection signal, the polarity of the first voltage signal and a polarity of the power pin are different, and the polarity of the second voltage signal and a polarity of the ground pin are different.

2. The vehicle electrical apparatus according to claim 1, wherein
the electrical device does not enable the first function when determining that according to the polarity detection signal, the polarities of the first voltage signal and the power pin are the same, and the polarities of the second voltage signal and the ground pin are the same.

3. The vehicle electrical apparatus according to claim 1, wherein
the electrical device enables a second function when determining that according to the polarity detection signal, the polarities of the first voltage signal and the power pin are the same, and the polarities of the second voltage signal and the ground pin are the same, wherein the first function and the second function are different.

4. The vehicle electrical apparatus according to claim 1, wherein the polarity detection circuit comprises:
a resistor, coupled between the power path and the control terminal of the electrical device to generate the polarity detection signal; and
a diode, having an anode terminal coupled to the control terminal of the electrical device and a cathode terminal coupled to the power pin.

5. The vehicle electrical apparatus according to claim 1, wherein the polarity detection circuit comprises:
a diode, having an anode terminal coupled to the power pin; and
a voltage-division circuit, coupled between a cathode terminal of the diode and the ground path to generate the polarity detection signal.

6. The vehicle electrical apparatus according to claim 1, wherein the polarity detection circuit comprises:
a resistor, coupled between the power path and the control terminal of the electrical device to generate the polarity detection signal; and
a diode, having an anode terminal coupled to the control terminal of the electrical device and a cathode terminal coupled to the ground pin.

7. The vehicle electrical apparatus according to claim 1, wherein the polarity detection circuit comprises:
a diode, having an anode terminal coupled to the ground pin; and
a voltage-division circuit, coupled between a cathode terminal of the diode and the ground path to generate the polarity detection signal.

8. The vehicle electrical apparatus according to claim 1, wherein the conversion circuit is a bridge rectifier.
